(19) United States
(12) Patent Application Publication
(10) Pub. No.: US 2016/0254894 A1
(43) Pub. Date: Sep. 1, 2016

(54) COMMUNICATION SYSTEM, BASE STATION APPARATUS, AND TERMINAL APPARATUS

(71) Applicant: SHARP KABUSHIKI KAISHA, Osaka-shi, Osaka (JP)

(72) Inventors: Hiromichi TOMEBA, Osaka-shi (JP); Takashi ONODERA, Osaka-shi (JP); Minoru KUBOTA, Osaka-shi (JP)

(21) Appl. No.: 15/032,723

(22) PCT Filed: Oct. 3, 2014
(86) PCT No.: PCT/JP2014/076581

§ 371 Date: Apr. 28, 2016

(30) Foreign Application Priority Data
Nov. 7, 2013 (JP) 2013-231256

(51) Int. Cl. H04L 5/00; H04B 7/04; H04B 7/06; H04W 72/04

(52) U.S. Cl. CPC H04L 5/0057; H04W 72/0406; H04B 7/0452; H04B 7/0626; H04W 88/08

(57) ABSTRACT

Provided are a communication system in which a base station apparatus and a terminal apparatus highly efficiently exchange channel state information based on different channel information norms, such a base station apparatus, and such a terminal apparatus. The base station apparatus chooses a channel information norm that the base station apparatus requests the terminal apparatus to conform to, generates control information containing information that designates the channel information norm, and transmits the control information to the terminal apparatus. The terminal apparatus receives the control information, estimates a channel between the terminal apparatus and the base station apparatus, generates channel state information between the terminal apparatus and the base station apparatus on the basis of the control information and the channel, and reports the channel state information to the base station apparatus.

### TECHNICAL FIELD

The present invention relates to a technology for performing multiple input and multiple output transmission.

### BACKGROUND ART

Attention has been focused on a multiple input and multiple output (MIMO) technology for performing wireless transmission using a plurality of transmitting and receiving antennas to achieve high-speed and high-capacity wireless communication in limited frequency bands, and the technology has been put into practical use in cellular systems, LAN systems, and the like. Further, frequency usage efficiency is effectively improved by multi-user MIMO (MU-MIMO), in which a plurality of terminal apparatuses that are simultaneously connected to a base station apparatus is deemed as a virtual large-scale array antenna and signals that are to be transmitted from the base station apparatus to each separate terminal apparatus are spatially multiplexed.

In MU-MIMO, it is necessary to suppress inter-user interference (IUI) between transmission signals destined for each separate terminal apparatus. For example, Long Term Evolution (LTE) and LTE-Advanced (LTE-A), which are known as the 3.9th and 4th generation mobile wireless communication systems, employ linear precoding, in which IUI is suppressed by multiplying a linear filter in advance in the base station apparatus.

Further, attention has been focused on a MU-MIMO technology that uses nonlinear precoding, in which nonlinear processing is performed on the side of the base station apparatus. In the case of a terminal apparatus that is capable of a modulo operation, the base station apparatus can add to, a signal to be transmitted to the terminal apparatus, a perturbation vector whose element is a complex number (perturbation term) obtained by multiplying a given Gaussian integer by a constant real number. Therefore, configuring the perturbation vector as appropriate according to channel state information (CSI) between the base station apparatus and the plurality of terminal apparatuses enables the base station apparatus to significantly reduce the required transmission power in comparison with linear precoding. Well-known examples of nonlinear precoding are vector perturbation (VP) and Tomlinson Harashima precoding (THP) (see NPL 1, NPL 2, etc.).

In order for the base station apparatus to perform MU-MIMO transmission, the base station apparatus needs MIMO channel information between the base station apparatus and a terminal apparatus. By a terminal apparatus reporting channel state information (CSI report) to the base station apparatus, the base station apparatus is allowed to determine a MIMO channel. An LTE system employs periodic channel state information reporting (periodic CSI reporting), in which a terminal apparatus periodically reports channel state information, and aperiodic channel state information reporting (aperiodic CSI reporting), in which a terminal apparatus reports channel state information in response to a channel state information reporting request (CSI trigger) from the base station apparatus (see PTL 1, etc.).

Further, frequency usage efficiency is effectively improved by adaptive modulation and coding (AMC), in which a terminal apparatus also notifies the base station apparatus of information associated with the reception quality of the terminal apparatus and the base station apparatus determines a code rate and a modulation and coding scheme (MCS) that are applied to a transmission signal destined for each terminal apparatus. Further, the information associated with the reception quality of the terminal apparatus is also useful for the base station apparatus to determine whether to perform MU-MIMO transmission.

In LTE, however, each terminal apparatus performs a CSI report on the assumption that it performs single-user MIMO (SU-MIMO) with the base station apparatus. This is because, at a point in time where the terminal apparatus performs a CSI report to the base station apparatus, the terminal apparatus cannot determine whether MU-MIMO transmission destined for the terminal apparatus is performed. This implies that the terminal apparatus performs a CSI report with a modulo operation out of the scope of the assumption.

### CITATION LIST

### Non Patent Literature

NPL 1: B. M. Hochwald, et. al., “A vector-perturbation technique for near-capacity multiantenna multiuser communication-Part II: Perturbation,” IEEE Trans. Commun., Vol. 53, No. 3, pp. 537-544, March 2005.
NPL 2: M. Joham, et. al., “MMSE approaches to multiuser spatio-temporal Tomlinson-Harashima precoding”, Proc. 5th Int. ITG Conf. on Source and Channel Coding, Erlangen, Germany, January 2004.

### Patent Literature

PTL 1: Japanese Unexamined Patent Application Publication No. 2012-235352

### SUMMARY OF INVENTION

### Technical Problem

The base station apparatus determines an MCS for a signal destined for each terminal apparatus on the basis of a CSI report from each terminal apparatus. In the conventional scheme, however, a CSI report from each terminal apparatus does not take a modulo operation into account. Therefore, in a case where the base station apparatus performs nonlinear precoding, the base station apparatus may be undesirably incapable of correctly configuring an MCS for a signal destined for each terminal apparatus.

Further, no terminal apparatus can always notify the base station apparatus of information associated with reception quality in all cases, as information associated with reception quality estimated by each terminal apparatus varies greatly, depending on access schemes in which the base station apparatus transmits a data signal to a terminal apparatus or differences in carrier frequencies, as well as precoding schemes. Therefore, the base station apparatus may be undesirably incapable of correctly configuring an MCS for a signal destined for each terminal apparatus.

The present invention has been made in view of these circumstances, and it is an object of the present invention to provide a communication system, a base station apparatus, and a terminal apparatus that allow each terminal apparatus to notify a base station apparatus of information associated with appropriate reception quality in a system in which the base station and the terminal apparatuses perform wireless communication on the basis of a plurality of technologies or radio resources.

### Solution to Problem

(1) In order to attain the foregoing object, the present invention takes the following measures: A communication system of the present invention is a communication system in which a terminal apparatus notifies a base station apparatus of channel state information (CSI), the base station apparatus including: a step of choosing a channel information norm from among a plurality of candidates as a norm of channel state information that the base station apparatus requests the terminal apparatus to conform to; a step of generating control information containing information that designates the chosen channel information norm; and a step of transmitting the control information to the terminal apparatus, the terminal apparatus including: a step of receiving the control information; a step of estimating a channel between the terminal apparatus and the base station apparatus; a step of generating channel state information between the terminal apparatus and the base station apparatus on a basis of the control information and the estimated channel between the terminal apparatus and the base station apparatus; and a step of reporting the channel state information to the base station apparatus, wherein the channel information norm includes a norm according to which the terminal apparatus calculates channel state information while taking a perturbation vector into account and a norm according to which the terminal apparatus calculates channel state information without taking a perturbation vector into account.

Such a communication system allows the base station apparatus to, in requesting the terminal apparatus for channel state information, designate whether to take a perturbation vector into account. This allows the base station apparatus to appropriately generate a data signal destined for each terminal apparatus on the basis of the channel state information of which the terminal apparatus notifies the base station apparatus. Further, on the basis of the control information of which the base station apparatus notifies the terminal apparatus, the terminal apparatus can determine whether to take a perturbation vector into account in calculating channel state information. This brings about improvement in reception quality of the terminal apparatus.

(2) Further, the communication system of the present invention is configured such that the terminal apparatus further includes: a step of estimating a channel between the terminal apparatus and a small-sized base station apparatus that is present in a range of communication with the base station apparatus; a step of generating channel state information between the terminal apparatus and the small-sized base station apparatus on a basis of the control information and the estimated channel between the terminal apparatus and the small-sized base station apparatus; and a step of reporting the channel state information between the terminal apparatus and the small-sized base station apparatus to the base station apparatus, and the base station apparatus further includes: a step of notifying the small-sized base station apparatus of the channel state information between the terminal apparatus and the small-sized base station apparatus as reported from the terminal apparatus; and a step of acquiring the channel state information of which the base station apparatus notified the small-sized base station apparatus.

Such a communication system allows the base station apparatus, the small-sized base station apparatus, and the terminal apparatus to exchange channel state information on the basis of different channel information norms. Further, the base station apparatus and the small-sized base station apparatus can appropriately generate a data signal destined for each terminal apparatus on the basis of the channel state information of which the terminal apparatus notifies the base station apparatus and the small-sized base station apparatus. This brings about improvement in reception quality of the terminal apparatus.

(3) Further, the communication system of the present invention is configured such that the control information further contains information that designates whether the terminal apparatus reports the channel state information to the base station apparatus or the small-sized base station apparatus.

Such a communication system allows the base station apparatus to designate a destination that the terminal apparatus notifies of channel state information, and allows the terminal apparatus to notify an appropriate destination of channel state information generated. This brings about improvement in reception quality of the terminal apparatus.

(4) Further, a base station apparatus of the present invention is a base station apparatus that receives channel state information from a plurality of terminal apparatuses, including: a control unit that chooses a channel information norm from among a plurality of candidates as a norm of channel state information that the base station apparatus requests each of the terminal apparatuses to conform to; a control information generation unit that generates control information containing information that designates the chosen channel information norm; and a wireless transmitting unit that transmits the control information to the terminal apparatus, wherein the channel information norm includes a norm according to which the terminal apparatus calculates channel state information while taking a perturbation vector into account and a norm according to which the terminal apparatus calculates channel state information without taking a perturbation vector into account.

Such a base station apparatus can designate, in requesting a terminal apparatus for channel state information, whether to take a perturbation vector into account, and therefore can appropriately generate a data signal destined for each terminal apparatus on the basis of channel state information of which the terminal apparatus notifies the base station apparatus. This brings about improvement in reception quality of the terminal apparatus.

(5) Further, the base station apparatus of the present invention is configured such that the channel state information reported from one or some of the plurality of terminal apparatuses is notified to a small-sized base station apparatus that is present in a range of communication with the base station apparatus.

Such a base station apparatus can notify a small-sized base station apparatus that is present in a range of communication with the base station apparatus of the channel state information reported from one or some of the plurality of terminal apparatuses, and therefore the small-sized base station apparatus can appropriately generate a data signal destined for a terminal apparatus that is present in a range of communication with the small-sized base station apparatus on the basis of the channel state information thus notified. This brings about improvement in reception quality of the terminal apparatus.

(6) Further, the base station apparatus of the present invention is configured such that the control information further contains information that designates whether the one or some of the plurality of terminal apparatuses report(s) the channel state information to the base station apparatus or the small-sized base station apparatus.

Such a base station apparatus can designate whether the one or some of the plurality of terminal apparatuses report(s) the channel state information to the base station apparatus or the small-sized base station apparatus. Therefore, the terminal apparatus(es) can notify an appropriate destination of the channel state information. This brings about improvement in reception quality of the terminal apparatus(es).

(7) Further, the base station apparatus of the present invention is configured to further include a plurality of channel quality indicator tables describing a plurality of combinations of a code rate and a modulation scheme, wherein the plurality of channel quality indicator tables correspond to the channel information norms, respectively.

Such a base station apparatus can use the plurality of channel quality indicator tables respectively associated with the plurality of channel information norms, and therefore can appropriately generate a data signal destined for a terminal apparatus on the basis of channel state information of which the terminal apparatus notified the base station apparatus. This brings about improvement in reception quality of the terminal apparatus.

(8) A terminal apparatus of the present invention is a terminal apparatus that notifies a base station apparatus of channel state information, including: a wireless receiving unit that receives control information containing information that designates a channel information norm that is a norm of channel state information transmitted from the base station apparatus; a propagation channel estimation unit that estimates a channel between the terminal apparatus and the base station apparatus; a channel state information generation unit that generates channel state information between the terminal apparatus and the base station apparatus on a basis of the channel information norm designated by the control information and the estimated channel between the terminal apparatus and the base station apparatus; and a wireless transmitting unit that transmits the channel state information to the base station apparatus, wherein the channel information norm includes a norm according to which the channel state information generation unit calculates channel state information while taking a perturbation vector into account and a norm according to which the channel state information generation unit calculates channel state information without taking a perturbation vector into account.

Such a terminal apparatus can determine, on the basis of control information containing information that designates a channel information norm that is a norm of channel state information of which the base station apparatus notifies the terminal apparatus, whether to take a perturbation vector into account in calculating channel state information, and therefore can notify the base station apparatus of the channel state information with high accuracy. This makes it possible to appropriately generate a data signal destined for the terminal apparatus, thus bringing about improvement in reception quality of the terminal apparatus.

(9) The terminal apparatus of the present invention is configured such that the propagation channel estimation unit estimates a channel between the terminal apparatus and a small-sized base station apparatus that is present in a range of communication with the base station apparatus, the channel state information generation unit generates channel state information between the terminal apparatus and the small-sized base station apparatus on a basis of the channel information norm designated by the control information and the estimated channel between the terminal apparatus and the small-sized base station apparatus, and the wireless transmitting unit transmits the channel state information between the terminal apparatus and the small-sized base station apparatus to the base station apparatus.

Such a terminal apparatus can determine, on the basis of the control information, whether to take a perturbation vector into account in calculating channel state information between the terminal apparatus and the small-sized base station apparatus, and therefore can generate the channel state information with high accuracy. This makes it possible to appropriately generate a data signal destined for the terminal apparatus, thus bringing about improvement in reception quality of the terminal apparatus.

(10) The terminal apparatus of the present invention is configured such that the wireless transmitting unit is capable of transmitting the channel state information between the terminal apparatus and the small-sized base station apparatus to the small-sized base station apparatus, the control information further contains information that designates whether to report the channel state information to the base station apparatus or the small-sized base station apparatus, and whether to report the channel state information between the terminal apparatus and the small-sized base station apparatus to the base station apparatus or the small-sized base station apparatus is determined on a basis of the control information.

Such a terminal apparatus can determine a destination of the channel state information between the terminal apparatus and the small-sized base station apparatus on the basis of the control information, and therefore can notify an appropriate destination of the channel state information. This makes it possible to appropriately generate a data signal destined for the terminal apparatus, thus bringing about improvement in reception quality of the terminal apparatus.

(11) The terminal apparatus of the present invention is configured to further include a plurality of channel quality indicator tables describing a plurality of combinations of a code rate and a modulation scheme, wherein the plurality of channel quality indicator tables correspond to the different channel information norms, respectively, and a channel quality indicator table that the channel state information generation unit uses is chosen on a basis of the control information.

Such a terminal apparatus can calculate channel state information with high accuracy on the basis of the plurality of channel quality indicator tables and notify the base station apparatus of the channel state information. This makes it possible to appropriately generate a data signal destined for the terminal apparatus, thus bringing about improvement in reception quality of the terminal apparatus.

### Advantageous Effects of Invention

According to the present invention, in a system in which a base station apparatus and a terminal apparatus perform wireless communication on the basis of a plurality of different technologies or wireless resources, each terminal apparatus can notify information associated with appropriate reception quality. This makes it possible to appropriately configure an MCS for a signal destined for each terminal apparatus, thus brining about improvement in transmission quality and, by extension, contributing to significant improvement in frequency usage efficiency of the wireless communication system.

### BRIEF DESCRIPTION OF DRAWINGS

FIG. 1 shows an example of an overview of a wireless communication system according to a first embodiment of the present invention.

FIG. 2 shows an example of a CQI table according to the first embodiment of the present invention.

FIG. 3 shows an example of a CSI request field according to the first embodiment of the present invention.

FIG. 4 shows an example of a CSI request field according to the first embodiment of the present invention.

FIG. 5 shows an example of a CSI request field and an example of a modulo operation request field according to the first embodiment of the present invention.

FIG. 6 is a sequence chart showing an example of communication according to the first embodiment of the present invention.

FIG. 7 is a block diagram showing an example of an apparatus configuration of a base station apparatus 1 according to the first embodiment of the present invention.

FIG. 8 is a flow chart showing an example of signal processing in the base station apparatus 1 according to the first embodiment of the present invention.

FIG. 9 is a flow chart showing an example of signal processing in the base station apparatus 1 according to the first embodiment of the present invention.

FIG. 10 is a block diagram showing an example of an apparatus configuration of a terminal apparatus 2 according to the first embodiment of the present invention.

FIG. 11 is a flow chart showing an example of signal processing in the terminal apparatus 2 according to the first embodiment of the present invention.

FIG. 12 is a flow chart showing an example of signal processing in the terminal apparatus 2 according to the first embodiment of the present invention.

FIG. 13 shows an example of a CQI table according to the second embodiment of the present invention.

FIG. 14 shows an example of a CQI table according to the second embodiment of the present invention.

FIG. 15 shows an example of an overview of a wireless communication system according to a third embodiment of the present invention.

FIG. 16 is a sequence chart showing an example of communication according to the third embodiment of the present invention.

### DESCRIPTION OF EMBODIMENTS

Embodiments in cases where a wireless communication system of the present invention is applied are described below with reference to the drawings.

The present invention is directed to a wireless communication system including the following base station apparatus and terminal apparatus: The base station apparatus aperiodically transmits, to the terminal apparatus, a downlink control signal containing information that requests a CSI report, and the terminal apparatus receives the downlink control signal, detects, from the downlink control signal, a trigger bit that requests a CSI report, and performs a CSI report to the base station apparatus.

The present invention is applicable to LTE, LTE-A, and their succeeding specifications. Further, the present invention is also applicable to changes or additions that may be made to the structures and/or formats of LTE, LTE-A, and their succeeding specifications in the future. The following describes main physical channels (or physical signals) used in LTE and LTE-A that are mainly related to the present invention. The term “channel” here means a medium that is used in the transmission of a signal, and the term “physical channel” here means a physical medium that is used in the transmission of a signal.

LTE and LTE-A use wireless frames to manage scheduling of physical channels. The duration of one wireless frame is 10 ms, and one wireless frame is constituted by ten subframes. Furthermore, one subframe is constituted by two slots (that is, the duration of one slot is 0.5 ms). Further, the management is implemented by using a resource block (RB) as a minimum unit of scheduling on which physical channels are allocated. The resource block is defined by a certain frequency domain constituted by a group of subcarriers (e.g., twelve subcarriers) on a frequency axis and a domain constituted by a certain transmission time interval (one slot) on a time axis.

A physical broadcast channel (PBCH) is transmitted from the base station apparatus for the purpose of notifying control parameters (broadcast information (system information) that are shared by terminal apparatuses within a cell. Broadcast information that is not notified through the physical broadcast channel is transmitted as a layer 3 message (system information) using a physical downlink shared channel (PDSCH) through which a radio resource was notified in a physical downlink control channel (PDCCH). As broadcast information, a cell global identifier (CGI) that indicates an identifier of an individual cell, a tracking area identifier (TAI) that manages an idle area by paging, random access configuration information (transmission timing timer), shared radio resource configuration information, and the like are notified. It should be noted that a layer 3 message is a control-plane message that is exchanged between the radio resource control (RRC) layers of a terminal apparatus and a base station apparatus, and may be used synonymously with RRC signaling or an RRC message.

Downlink reference signals are classified into a plurality of types depending on their applications. For example, cell-specific reference signals (CRSs) are pilot signals that are transmitted with predetermined power for each separate cell, and are downlink reference signals that are periodically repeated in a frequency domain and a time domain on the basis of a predetermined rule. The terminal apparatus measures the reception quality of each separate cell by receiving these cell-specific reference signals. Further, the terminal apparatus also uses the downlink cell-specific reference signals to refer to for demodulation of physical downlink control channels and physical downlink shared channels that are transmitted simultaneously with the cell-specific reference signals. Sequences that can be identified for each separate cell are used for the cell-specific reference signals.

Further, downlink reference signals can also be used in the estimation of a downlink propagation channel state. In the estimation of a propagation channel state, cell-specific reference signals corresponding to up to four antennas are used, and in addition to this, LTE-A can utilize channel state information reference signals (CSI-RSs) corresponding to up to eight antennas.

Further, there are UE-specific reference signals or demodulation reference signals (DM-RSs) as downlink reference signals that are configured for each separate terminal apparatus. The UE-specific reference signals are used in the demodulation of a physical downlink control channel or a physical downlink shared channel.

A physical downlink control channel is transmitted using the first few OFDM symbols of each subframe, and is used for the purpose of notifying downlink control information (DCI) describing radio resource allocation information based on a result of scheduling of the base station apparatus or information indicating to the terminal apparatus an amount of adjustment of an increase or decrease in uplink transmission power. The terminal apparatus needs to monitor a physical downlink control channel addressed thereto prior to receiving downlink user data, receiving a layer 3 message (such as paging, a handover command), which is downlink control data, or transmitting uplink user data or the like, and thereby acquire radio resource allocation information called an uplink grant to uplink transmission or a downlink grant (downlink assignment) to downlink reception. It should be noted that instead of being transmitted using the aforementioned first few ODFM symbols of each subframe, the physical downlink control channel may be transmitted using a region of a resource block that is dedicatedly allocated from the base station apparatus to the terminal apparatus.

A physical uplink control channel (PUCCH) is used for notifying an acknowledgement response (ACK) and a negative acknowledgement (NACK or NAK) to data transmitted through a physical downlink shared channel, downlink propagation channel state information (CSI), or a scheduling request (SR) that is an uplink radio resource allocation request (radio resource request).

A physical downlink shared channel (PDSCH) is used for notifying the terminal apparatus of, as a layer 3 message, paging and broadcast information (system information) that is not notified through a physical broadcast channel, as well as for transmitting downlink data. Radio resource allocation information on the physical downlink shared channel is indicated by a physical downlink control channel.

A physical uplink shared channel (PUSCH) mainly transmits uplink data and uplink control data, and may contain control data such as downlink CSI and ACK/NACK to downlink data or the like. Further, the physical uplink shared channel is also used for notifying the base station apparatus of uplink control information as a layer 3 message, as well as for transmitting uplink data. Further, as with the radio resource allocation information on the physical downlink shared channel, radio resource allocation information on the physical uplink shared channel is indicated by a physical downlink control channel. Further, in a case where uplink control information (UCI) is not transmitted through a PUSCH, the UCI is transmitted through a PUCCH.

An uplink reference signal (also referred to as “uplink pilot signal” or “uplink pilot channel”) contains a demodulation reference signal (DM-RS) that the base station apparatus uses to demodulate a physical uplink control channel and a physical uplink shared channel and a sounding reference signal (SRS) that the base station apparatus mainly uses to estimate an uplink channel state. Further, the sounding reference signal is either a periodic sounding signal (periodic SRS) or an aperiodic sounding signal (aperiodic SRS).

A physical random access channel (PRACH) is a channel that is used for notifying a preamble sequence, and has guard time. The preamble sequence is configured to prepare 64 types of sequence to express 6 bits of information. The physical random access channel is used as means of access by the terminal apparatus to the base station apparatus. The terminal apparatus uses a physical random access channel to make a radio resource allocation request when a physical uplink control channel has not been configured yet or to request the base station apparatus for transmission timing adjustment information (also called timing advance (TA)) that is needed to synchronize an uplink transmission timing with a reception timing window of the base station apparatus.

Wireless communication systems according to embodiments of the present invention each include a base station apparatus (transmitting apparatus, cell transmitting point, transmitting antenna group, transmitting antenna port group, eNodeB) and a terminal apparatus (mobile terminal, receiving point, receiving terminal, receiving apparatus, receiving antenna group, receiving antenna port group, UE), and the base station apparatus transmits control information and information data through a downlink in order to perform data communication with the terminal apparatus.

Communication technologies according to the embodiments of the present invention are described below with reference to the drawings. It should be noted that matters described in the embodiments are aspects for understanding the invention and interpretation of the contents of the invention should not be limited to the embodiments.

### 1. First Embodiment

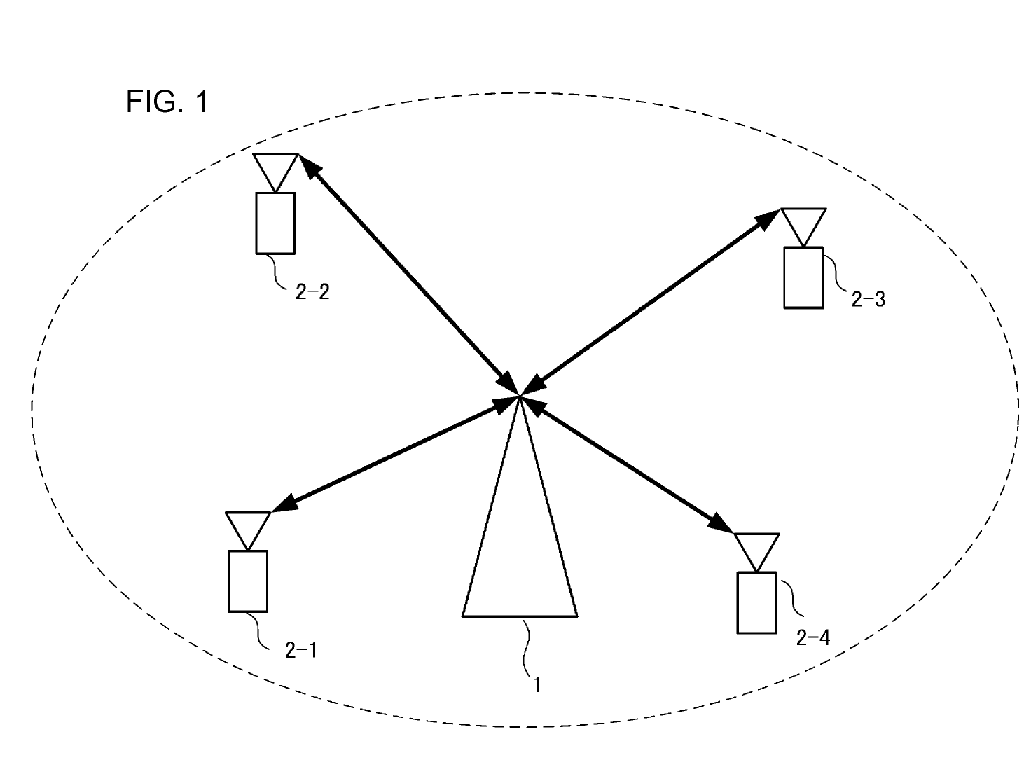

FIG. 1 shows an example of an overview of a wireless communication system according to a first embodiment of the present invention. The first embodiment assumes that a plurality of terminal apparatuses 2 (also called wireless receiving apparatuses) (in FIG. 1, four terminal apparatuses 2-1 to 2-4) are connected to a base station apparatus 1 (also called a wireless transmitting apparatus) that is capable of precoding MU-MIMO including nonlinear precoding.

Each of the terminal apparatuses 2 receives at least either a cell-specific reference signal or a channel state information reference signal transmitted from the base station apparatus 1, estimates a downlink channel state between each transmitting antenna of the base station apparatus 1 and each receiving antenna of the terminal apparatus 2, and reports channel state information (CSI) to the base station apparatus 1 by uplink transmission on the basis of the propagation channel state (which is called a CSI report). The base station apparatus 1 selects a plurality of terminal apparatuses 2 on the basis of the CSI reports and the like from each terminal apparatus 2 and performs MU-MIMO transmission in which data to be transmitted to the plurality of terminal apparatuses 2 are spatially multiplexed for simultaneous transmission.

As means by which each of the terminal apparatuses 2 reports CSI to the base station apparatus 1, an LTE system has two schemes, namely periodic feedback and aperiodic feedback. The two scheme are periodic channel state information reporting (periodic CSI reporting) and aperiodic channel state information reporting (aperiodic CSI reporting). In the periodic channel state information reporting, the terminal apparatus 2 feeds back the CSI to the base station apparatus 1 in accordance with a predetermined period.

In the aperiodic channel state information reporting, the base station apparatus 1 transmits an aperiodic channel state information reporting request signal (also called a CSI trigger bit or, simply, a CSI trigger). In a case where the terminal apparatus 2 has detected a CSI trigger bit contained in a downlink control signal, the terminal apparatus 2 performs a single CSI report to the base station apparatus 1. In the LTE system, the terminal apparatus 2 reports aperiodic channel state information to the base station apparatus 1 through a PUSCH.

CSI mainly contains the following information: information regarding a MIMO channel between the base station apparatus 1 and the terminal apparatus 2, information regarding the reception quality of the terminal apparatus 2, and information regarding the number of request data streams of the terminal apparatus 2. A MIMO channel is expressed by a matrix whose elements are complex channel gains between each transmitting antenna of the base station apparatus 1 and each receiving antenna of the terminal apparatus 2.

As the information regarding a MIMO channel (also called MIMO channel information), LTE and LTE-A defines a precoding matrix indicator (PMI) that indicates desirable precoding information to a MIMO channel estimated by the terminal apparatus 2. It should be noted that the term “indicator” may be denoted by “indication” and these two terms are the same in application and meaning.

The first embodiment may use, as the information regarding a MIMO channel, information directly indicating a MIMO channel estimated by the terminal apparatus 2. The information directly indicating a MIMO channel may be information obtained by directly quantizing, by a finite bit number, the value of a MIMO channel estimated by the terminal apparatus 2 or information obtained by quantizing, by a finite bit number, a value obtained by performing some sort of signal processing (averaging, interpolation, eigenvalue decomposition, singular value decomposition, inverse discrete Fourier transform, or cosine transform) on the estimated MIMO channel.

As the information regarding the number of request data streams of the terminal apparatus 2, LTE and LTE-A defines a rank indicator (RI) that indicates the most desirable number of data streams (rank number) to a MIMO channel estimated by the terminal apparatus 2.

As the information regarding the reception quality of the terminal apparatus 2, LTE and LTE-A defines a channel quality indicator (CQI) that, on the basis of a MIMO channel estimated by the terminal apparatus 2, indicates the frequency usage efficiency most suitable for application in a PDSCH.

The following description uses terms that are used for the aforementioned LTE and LTE-A. Note, however, the present invention is also applicable to a different wireless communication system, provided control defined in the same meaning is performed.

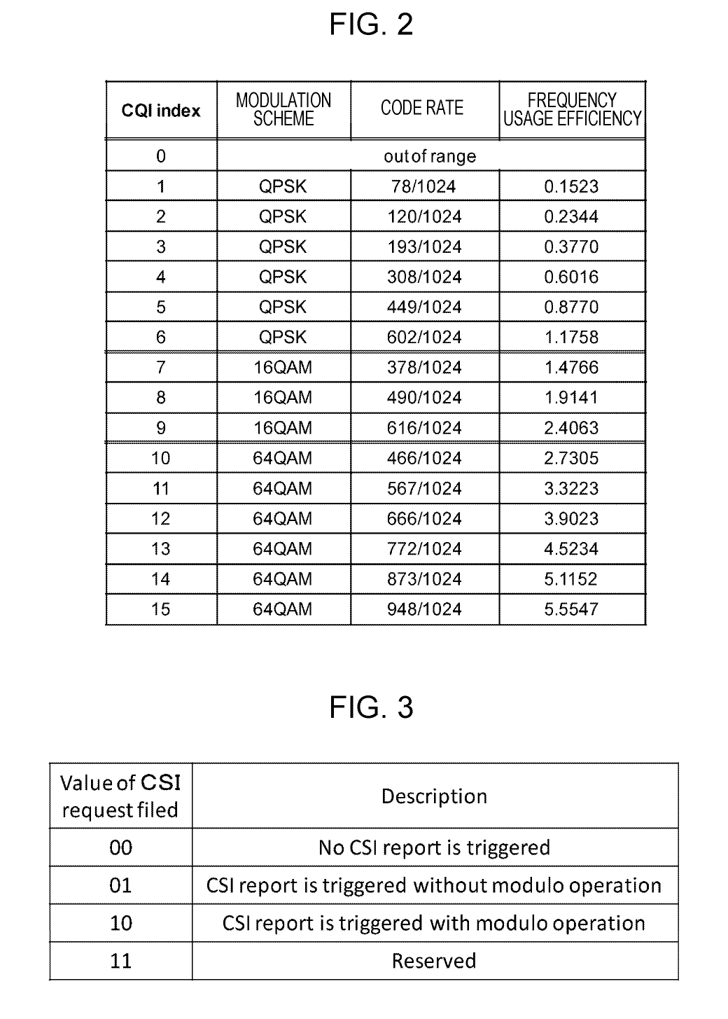

FIG. 2 shows an example of a CQI table. The terminal apparatus 2 estimates a received signal-to-interference plus noise power ratio (SINR) in the case of reception of a data signal (e.g., a signal that is transmitted through a PDSCH) on the basis of an estimated MIMO channel, PMI, RI, and a reception detection scheme. Then, the terminal apparatus 2 calculates an MCS that gives the maximum frequency usage efficiency that satisfies the required reception quality with the estimated received SINR. Then, the terminal apparatus 2 extracts, from the CQI table, a value that is closest to the frequency usage efficiency and notifies the base station apparatus 1 of an index thereof.

As noted above, CQI also depends on the reception detection scheme of the terminal apparatus 2. In the first embodiment, the base station apparatus 1 can perform precoding including nonlinear precoding on a data signal destined for each terminal apparatus 2. In a case where nonlinear precoding is performed on a data signal, an offset vector called a perturbation vector is added in advance to a data signal destined for each terminal apparatus 2. A perturbation vector is effective in preventing an enhancement in the required transmission power that occurs where the base station apparatus 1 performs MU-MIMO transmission.

In a case where the terminal apparatus 2 has received a data signal subjected to nonlinear precoding, the terminal apparatus 2 needs to perform reception detection while taking into account the perturbation vector added to the data signal. At this point in time, a nonlinear operation called a modulo operation is generally used.

A modulo operation is an operation in which offset vectors at regular intervals are added to an input signal so that the signal inputted falls within constant amplitude. The terminal apparatus 2 can perform a modulo operation to eliminate the perturbation vector that the base station apparatus 1 added to the data signal.

Further, since the addition of a perturbation vector to a data signal by the base station apparatus 1 is equivalent to the selection of a given signal candidate point from a signal point space in which original modulation signal candidate points are repeated on a complex plane, the terminal apparatus 2 is capable of detecting a desired signal by performing maximum-likelihood detection on received signals. In the following, performing signal detecting while taking a perturbation vector into account is referred to as performing signal detecting while taking a modulo operation into account.

However, a modulo operation undesirably reduces the area of a signal determination plane. Therefore, in a case where the reception quality is the same as before a modulo operation, performing a modulo operation undesirably results in deterioration in the reception quality after reception detection. This implies that the reception quality that the terminal apparatus 2 estimates varies greatly, depending on whether a modulo operation is applied.

A method in which the terminal apparatus 2 always calculates CQI on the premise of a modulo operation is conceivable. However, the base station apparatus 1 does not always perform nonlinear precoding on a data signal. This is because whether the base station apparatus 1 performs nonlinear precoding is determined on the basis of a CSI report from the terminal apparatus 2.

Therefore, in the first embodiment, the base station apparatus 1 incorporates, into a CSI trigger for the terminal apparatus 2, information that designates whether the terminal apparatus 2 takes a modulo operation into account. In the following, signal processing or a norm, such as a modulo operation to which the first embodiment is directed, that the terminal apparatus 2 takes into account in performing a CSI report is referred to as a channel information norm.

For example, the base station apparatus 1 incorporates one bit into a CSI trigger for the terminal apparatus 2. When the one bit thus incorporated is “0”, the terminal apparatus 2 calculates CSI without taking a modulo operation into account, and when the one bit thus incorporated is “1”, the terminal apparatus 2 calculates CSI while taking a modulo operation into account.

Such control allows the terminal apparatus 2 to determine, on the basis of the CSI trigger, whether to take a modulo operation into account. Further, since the base station apparatus 1 can request each terminal apparatus 2 to conform to a desired channel information norm, the base station apparatus 1 can more highly efficiently determine an MCS for a data signal destined for the terminal apparatus 2 to which nonlinear precoding has been applied.

Further, LTE-A is configured to be able to perform communication in a plurality of serving cells of different component carriers. Therefore, by using a value in a CSI request field that indicates a CSI trigger contained in DCI, the base station apparatus 1 can designate which serving cell has its CSI reported by the terminal apparatus 2. Accordingly, in the first embodiment, too, by changing the contents of the CSI request field, adding new information to the CSI request field, or adding a new request field to the DCI, the base station apparatus 1 may designate whether the terminal apparatus 2 performs a modulo operation.

FIG. 3 shows an example of a CSI request field according to the first embodiment. In the example shown in FIG. 3, the terminal apparatus 2 does not perform a CSI report in the case of a two-bit value of “00”. In the case of a two-bit value of “01”, the terminal apparatus 2 performs a CSI report. However, the terminal apparatus 2 calculates CSI on the premise that it does not perform a modulo operation. In the case of a two-bit value of “10”, the terminal apparatus 2 performs a CSI report. In so doing, the terminal apparatus 2 presupposes that it performs a modulo operation.

According to the example shown in FIG. 3, the terminal apparatus 2 can determine, in accordance with a value in the CSI request field, whether it takes a modulo operation into account in calculating CQI. Further, the base station apparatus 1 can more highly efficiently determine whether to apply nonlinear precoding, as it can request each terminal apparatus 2 for a desired CSI report.

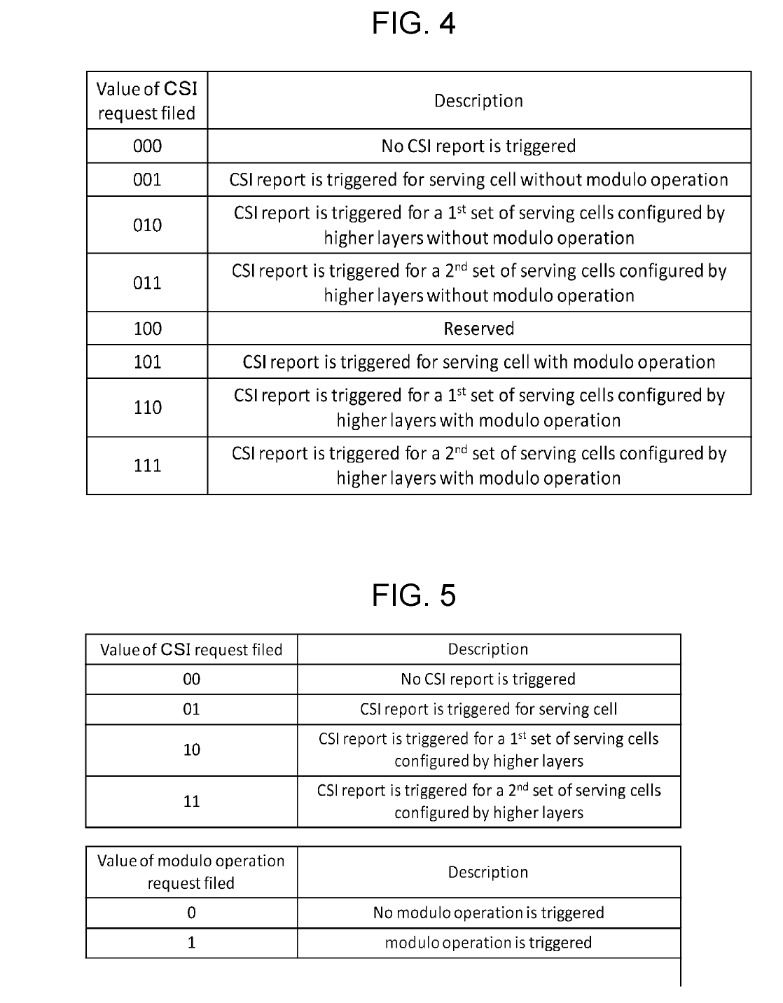

FIG. 4 shows another example of a CSI request field according to the first embodiment. In the example shown in FIG. 4, as in the conventional LTE-A system, in an environment where a plurality of serving cells are utilized, the terminal apparatus 2 can grasp whether to take modulo operation into account. For example, in the case of a three-bit value of “000”, the terminal apparatus 2 does not perform a CSI report. In the case of a three-bit value of “001”, the terminal apparatus 2 reports CSI regarding a serving cell of a downlink component carrier corresponding to a PUSCH, but presupposes that it does not perform a modulo operation. In the case of a three-bit value of “110”, the terminal apparatus 2 reports CSI regarding at least one serving cell designated as a first set by another signaling (e.g., a higher-layer signaling such as an RRC signaling), and presupposes that it performs a modulo operation. The use of such a CSI request field allows the terminal apparatus 2, even in an environment where a plurality of serving cells are used for communication, to determine, in accordance with a value in the CSI request field, whether it takes a modulo operation into account in calculating the CQI of each serving cell. It should be noted that all of the plurality of serving cells are not limited to those which are transmitted from the same base station apparatus 1. For example, a case where at least one serving cell designated as a first set is controlled to be transmitted from another base station apparatus 1 is encompassed.

Further, separately from the existing CSI request field, a field for designating whether to take a modulo operation into account may be newly added. FIG. 5 shows an example of a CSI request field and an example of a modulo operation request field according to the first embodiment. The CSI request field is the same as that used in the existing LTE-A system. The terminal apparatus 2 further determines, on the basis of a value in the modulo operation request field, whether to perform a modulo operation. That is, with “0” configured, the terminal apparatus 2 estimates CSI without taking a modulo operation into account. On the other hand, with “1” configured, the terminal apparatus 2 estimates CSI while taking a modulo operation into account.

Further, the meanings of descriptions in the existing CSI request field may be changed by another signaling. For example, in a case where the terminal apparatus 2 is configured by a higher-layer signaling to estimate CSI while taking a modulo operation into account, the terminal apparatus 2 performs a CSI report on the premise that it performs a modulo operation on the data signal, regardless of the descriptions in the CSI request field.

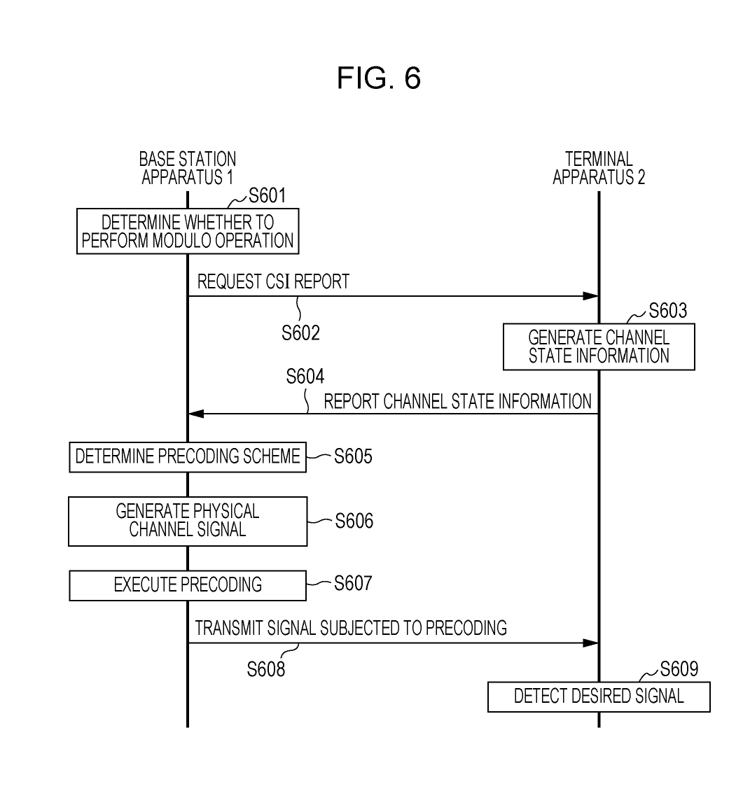

FIG. 6 is a sequence chart showing an example of communication between the base station apparatus 1 and the terminal apparatus 2 according to the first embodiment. FIG. 6 shows only a part of the communication that is relevant to a CSI report. Further, FIG. 6 shows only one terminal apparatus 2, although a plurality of terminal apparatuses 2 perform the same communication in an actual system. It should be noted that references signals, such as a CRS and a CSI-RS, by which each terminal apparatus 2 estimates CSI are periodically communicated by another control.

First, the base station apparatus 1 determines whether to request each terminal apparatus 2 for a CSI report with a modulo operation taken into account (step S601). The first embodiment is not limited to any particular determination method. However, for example, a method is conceivable in which a terminal apparatus 2 for which a modulation scheme having a comparatively high modulation level has hitherto been used in the transmission of a PDSCH is requested by the base station apparatus 1 for a CSI report with a modulo operation taken into account. This is because deterioration in characteristics due to a modulo operation in a terminal apparatus 2 is smaller when the modulation scheme has a higher modulation level and it is desirable that nonlinear precoding be performed on a data signal destined for such a terminal apparatus 2.

Next, the base station apparatus 1 transmits, to each terminal apparatus 2, a signal (CSI trigger) to request for a CSI report (step S602). For example, the base station apparatus 1 needs only incorporate the aforementioned CSI request field into DCI, which is a downlink control signal to each terminal apparatus 2, and transmit the DCI.

Next, on the basis of the CSI trigger notified from the base station apparatus 1, the terminal apparatus 2 determines whether to perform a modulo operation and generates channel state information (step S603). Then, the terminal apparatus 2 reports the channel state information to the base station apparatus 1 (step S604).

Next, on the basis of the CSI report from the terminal apparatus 2, the base station apparatus 1 determines a precoding scheme that is applied to a data signal destined for each terminal apparatus 2 (step S605).

Next, on the basis of the precoding scheme thus determined and the CSI report from the terminal apparatus 2, the base station apparatus 1 determines an MCS that is applied to the data signal and generates a physical channel signal (step S606). For example, the physical channel signal is a signal that is transmitted through a PDSCH.

Next, the base station apparatus 1 performs precoding on the physical channel signal thus generated (step S607). Then, the base station apparatus 1 transmits, to each terminal apparatus 2, the signal subjected to precoding (step S608).

Next, the terminal apparatus 2 demodulates a desired signal from the signal received (step S609).

This is an example of communication between the base station apparatus 1 and the terminal apparatus 2 according to the first embodiment. Such communication enables the terminal apparatus 2 determine, in calculating CSI, whether to perform a modulo operation, and allows the base station apparatus 1 to ask each terminal apparatus 2 whether to perform a modulo operation at the time of CSI calculation.

[1.1. Base Station Apparatus 1]

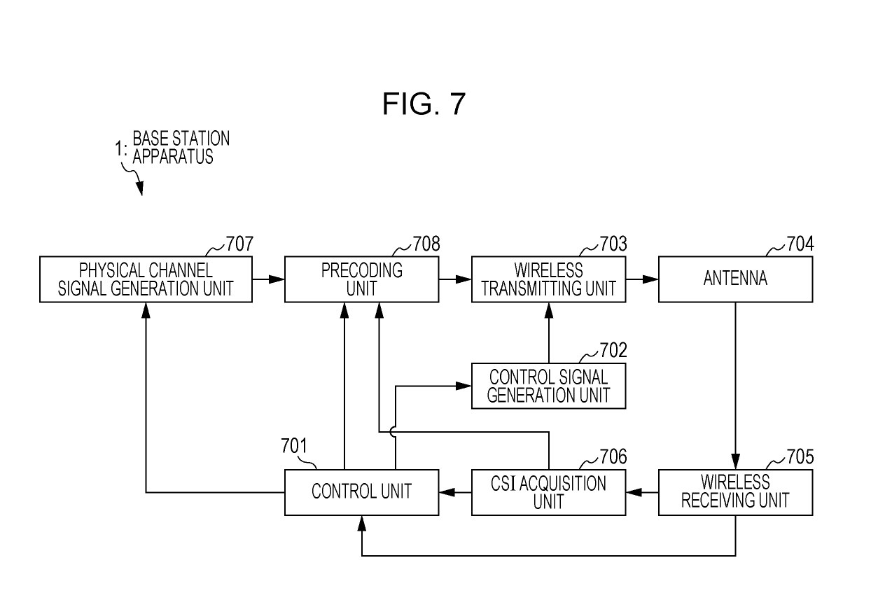

FIG. 7 is a block diagram showing an example configuration of the base station apparatus 1 according to the first embodiment. As shown in FIG. 7, the base station apparatus 1 includes a control unit 701, a control signal generation unit 702, a wireless transmitting unit 703, an antenna 704, a wireless receiving unit 705, a CSI acquisition unit 706, a physical channel signal generation unit 707, and a precoding unit 708.

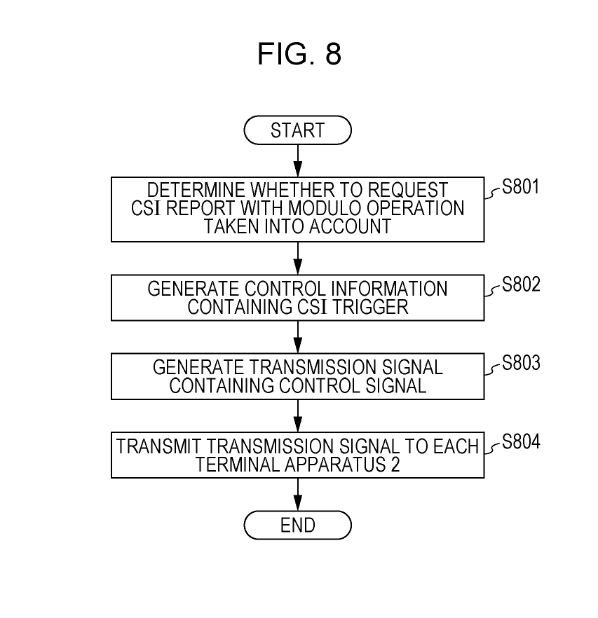

FIG. 8 is a flow chart showing an example of signal processing in which the base station apparatus 1 according to the first embodiment requests the terminal apparatus 2 for a CSI report.

First, the control unit 701 determines whether to request the terminal apparatus 2 for a CSI report with a modulo operation taken into account (step S801). The control unit 701 determines, according to the CSI reports hitherto received from the terminal apparatus 2, the maximum number of spatial multiplexing terminals that are multiplexed in MU-MIMO transmission, and the like, whether to request each terminal apparatus 2 for a CSI report with a modulo operation taken into account.

Next, on the basis of the determination made by the control unit 701 as to whether to take a modulo operation into account, the control signal generation unit 702 generates a control signal destined for each terminal apparatus 2 that contains a CSI trigger (step S802). For example, the control signal generation unit 702 generates DCI destined for each terminal apparatus 2 that contains such a CSI request field and/or a modulo operation request field as those shown in FIGS. 3 to 5.

Next, the wireless transmitting unit 703 generates a transmission signal containing the control signal generated by the control signal generation unit 702 (step S803). The wireless transmitting unit 703 subjects the control signal to processing such as channel encoding, data modulation, resource allocation, orthogonal frequency division multiplexing modulation, up-conversion into a radio frequency (RF). Then, the transmission signal generated by the wireless transmitting unit 703 is transmitted to each terminal apparatus 2 via the antenna 704 (step S804). This is an example of signal processing in which the base station apparatus 1 according to the first embodiment requests the terminal apparatus 2 for a CSI report.

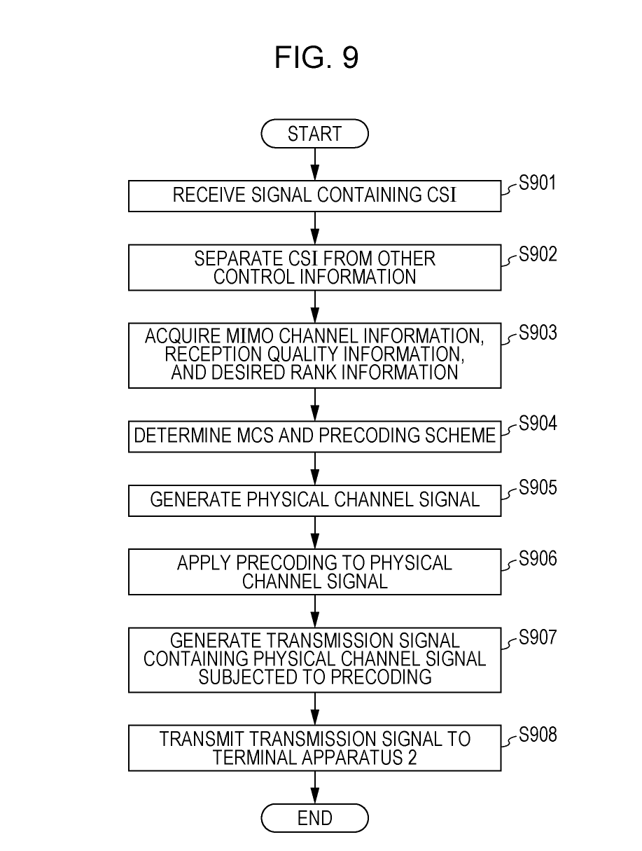

FIG. 9 is a flow chart showing an example of signal processing in which the base station apparatus 1 according to the first embodiment performs precoding transmission to each terminal apparatus 2 on the basis of a CSI report from the terminal apparatus 2. It should be noted that the base station apparatus 1 does not always exclusively performs the examples of signal processing shown in FIGS. 8 and 9 and may perform parts of the signal processing in parallel.

First, the base station apparatus 1 receives via the antenna 704 a signal containing CSI that is transmitted from each terminal apparatus 2 (step S901). Then, the wireless receiving unit 705 separates the signal inputted from the antenna 704 into information regarding CSI and the other information, inputs the information regarding CSI to the CSI acquisition unit 706, and inputs the other information to the control unit 701 (step S902).

Next, the CSI acquisition unit 706 acquires information such as MIMO channel information (e.g., PMI), reception quality information (e.g., CQI), and desired rank information (e.g., RI) from the information regarding CSI inputted from the wireless receiving unit 705 and inputs them to the control unit 701 and the precoding unit 708 (step S903).

Next, on the basis of the control signals inputted from the CSI acquisition unit 706 and the wireless receiving unit 705, the control unit 701 determines an MCS and a precoding scheme that are applied to a data signal (e.g., a data signal that is transmitted to each terminal apparatus 2 through a PDSCH) (step S904).

Note here that linear precoding (first precoding), nonlinear precoding (second precoding), and a combination of linear precoding and non-linear precoding (third precoding) are applicable as the precoding scheme in the first embodiment.

Linear precoding refers to precoding in which IUI is suppressed using only a linear filter that is calculated from a MIMO channel. Examples of linear precoding include zero forcing (ZF) normative precoding, and minimum mean square error (MMSE) normative precoding. Nonlinear precoding refers to precoding in which, after a perturbation vector has been added to the data signal in advance, IUI is suppressed using only a linear filter that is calculated from a MIMO channel. Examples of nonlinear precoding include VP and THP. The combination of linear precoding and non-linear precoding refers to precoding in which, in nonlinear precoding, no perturbation vectors are added to data signals destined for some terminal apparatuses 2.

The control unit 701 determines the precoding scheme on the basis of whether, at the time of CSI trigger transmission, the base station apparatus 1 requested each terminal apparatus 2 to take a modulo operation into account. Specifically, the base station apparatus 1 does not add a perturbation vector to a data signal destined for a terminal apparatus 2 (first terminal apparatus) that the base station apparatus 1 requested for a CSI report without a moduo operation taken into account. On the other hand, the base station apparatus 1 adds a perturbation vector to a data signal destined for a terminal apparatus 2 (second terminal apparatus) that the base station apparatus 1 requested for a CSI report with a moduo operation taken into account.

Therefore, if all of the terminal apparatuses 2 that are spatially multiplexed are first terminal apparatuses, the control unit 701 decides to perform the first precoding. Alternatively, if all of the terminal apparatuses 2 that are spatially multiplexed are second terminal apparatuses, the control unit 701 decides to perform the second precoding. Alternatively, if some of the terminal apparatuses 2 that are spatially multiplexed are first terminal apparatuses and others are second terminal apparatuses, the control unit 701 decides to perform the third precoding.

Next, the physical channel signal generation unit 707 generates a physical channel signal on the basis of the information inputted from the control unit 701 (step S905). The physical channel signal is for example a data signal that is transmitted to each terminal apparatus 2 through a PDSCH. The physical channel signal generation unit 707 performs digital signal processing such as channel encoding and data modulation on an information bit sequence destined for each terminal apparatus 2, multiplexing of reference signals such as CRSs, and resource allocation to data signals and reference signals.

Next, the precoding unit 708 performs precoding on at least some physical channel signals on the basis of the precoding scheme determined by the control unit 701 and the MIMO channel information acquired by the CSI acquisition unit 706 (step S906).

Next, the wireless transmitting unit 703 generates a transmission signal containing the physical channel signals subjected to precoding (step S907). The transmission signal thus generated is transmitted to each terminal apparatus 2 via the antenna 704 (step S908).

[1.2. Terminal Apparatus 2]

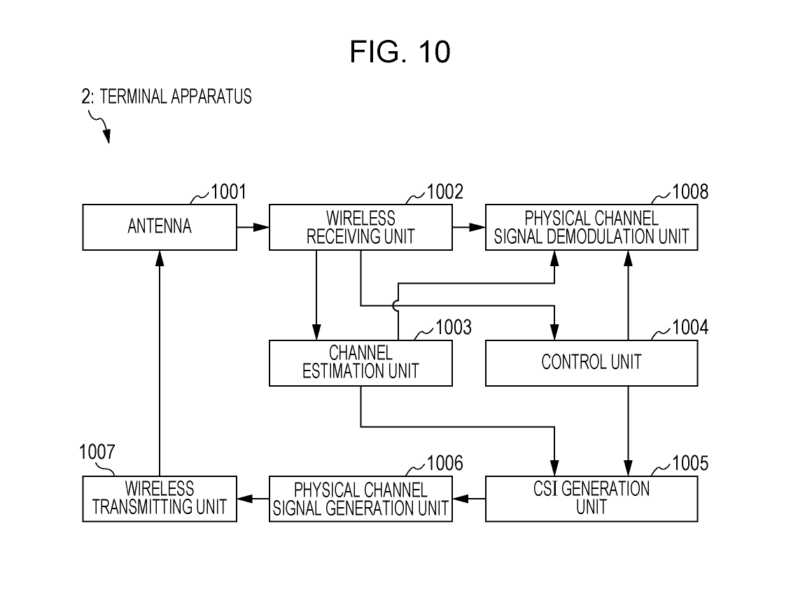

FIG. 10 is a block diagram showing an example configuration of the terminal apparatus 2 according to the first embodiment. As shown in FIG. 10, the terminal apparatus 2 includes an antenna 1001, a wireless receiving unit 1002, a channel estimation unit 1003, a control unit 1004, a channel state information (CSI) generation unit 1005, a physical channel signal generation unit 1006, a wireless transmitting unit 1007, and a physical channel signal demodulation unit 1008.

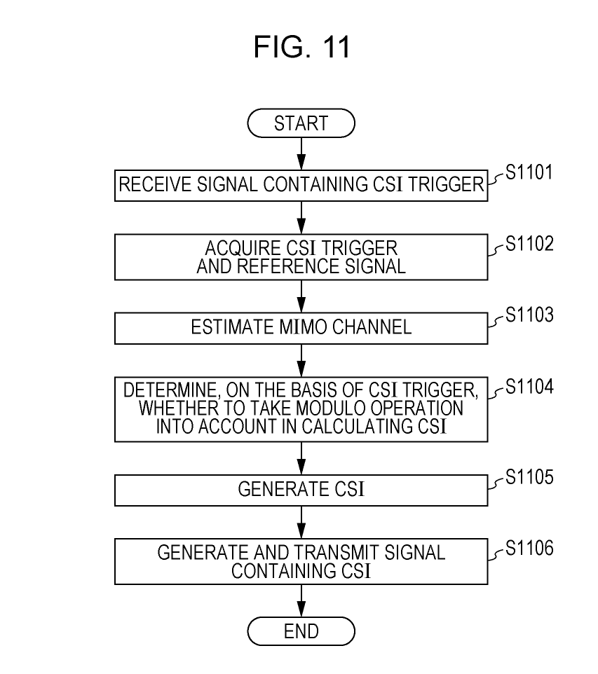

FIG. 11 is a flow chart showing an example of signal processing in which the terminal apparatus 2 according to the first embodiment performs a CSI report to the base station apparatus 1.

First, the terminal apparatus 2 receives via the antenna 1001 a signal containing a CSI trigger that is transmitted from the base station apparatus 1 (step S1101). The wireless receiving unit 1002 receives a control signal via the antenna 1001, converts the control signal into a baseband signal. After that, the wireless receiving unit 1002 extracts control information containing the CSI trigger from the signal containing the CSI trigger and inputs the control information to the control unit 1004. Further, the wireless receiving unit 1002 separately receives reference signals such as a CRS and a CSI-RS and inputs the reference signals to the channel estimation unit 1003 (step S1102).

Next, the channel estimation unit 1003 estimates a MIMO channel between the terminal apparatus 2 and the base station apparatus 1 on the basis of CRSs and CSI-RSs that are periodically transmitted from the base station apparatus 1 (step S1103).

Next, the control unit 1004 determines, on the basis of the CSI trigger, whether to take a modulo operation into account in calculating CSI (step S1104). For example, the control unit 1004 needs only read a value in a CSI request field to determine whether to take a modulo operation into account. It should be noted that the determination as to whether to take a modulo operation into account is also used at the time of the after-mentioned demodulation of a physical channel signal.

Next, the CSI generation unit 1005 generates CSI on the basis of the MIMO channel estimated by the channel estimation unit 1003 and the determination made by the control unit 1004 as to whether to take a modulo operation into account (step S1105). For example, in a case of taking a modulo operation into account in calculating CQI, it is only necessary to estimate a received SINR from the MIMO channel using a reception detection scheme including a modulo operation, calculate the frequency usage efficiency, and determine the CQI.

For example, the physical channel signal generation unit 1006 generates a transmission signal containing the CSI and a data signal that is transmitted to the base station apparatus 1. For example, the signal that the physical channel signal generation unit 1006 generates is a signal that is transmitted through a PUSCH. Then, the wireless transmitting unit 1007 converts the transmission signal destined for the base station apparatus 1 into a wireless transmission signal in an RF band. Then, the terminal apparatus 2 transmits the wireless transmission signal to the base station apparatus 1 via the antenna 1001 (step S1106).

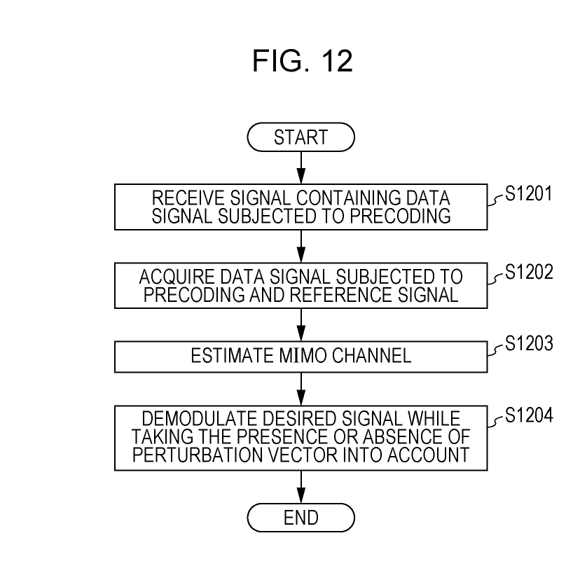

FIG. 12 is a flow chart showing an example of signal processing in the terminal apparatus 2 according to the first embodiment demodulates a data signal subjected to precoding and transmitted from the base station apparatus 1. For example, the data signal subjected to precoding and transmitted from the base station apparatus 1 is a signal that is transmitted through a PDSCH. It should be noted that the terminal apparatus 2 does not always exclusively performs the examples of signal processing shown in FIGS. 11 and 12 and may perform parts of the signal processing in parallel.

First, the terminal apparatus 2 receives via the antenna 1001 a signal containing the data signal subjected to precoding and transmitted from the base station apparatus 1 (step S1201). The wireless receiving unit 1002 converts the signal received via the antenna 1001 into a baseband signal and then inputs the data signal subjected to precoding to the physical channel signal demodulation unit 1008. Further, the wireless receiving unit 1002 separately receives a reference signal such as a DMRS and inputs the reference signal to the channel estimation unit 1003 (step S1202).

Next, the channel estimation unit 1003 estimates, on the basis of the DMRS and the like, MIMO channel information for demodulating the data signal subjected to precoding (step S1203).

Next, the physical channel signal demodulation unit 1008 demodulates a desired signal from the data signal subjected to precoding on the basis of the MIMO channel information for demodulating the data signal subjected to precoding (step S1204). The physical channel signal demodulation unit 1008 subjects the data signal subjected to precoding to spatial detection processing, resource de-mapping, data demodulation, channel demodulation, and the like based on linear filtering, interference canceller, maximum-likelihood detection, turbo detection, and a combination or repetition of these. At this point in time, in a case where the CSI generation unit 1005 has generated the CSI with a modulo operation taken into account, the physical channel signal demodulation unit 1008 performs signal demodulation including signal processing (e.g., a modulo operation) with the perturbation vector taken into account. On the other hand, in a case where the CSI generation unit 1005 has generated the CSI without a modulo operation taken into account, the physical channel signal demodulation unit 1008 performs signal demodulation without taking the perturbation vector into account.

The communication method, the base station apparatus, and the terminal apparatus thus described allow the base station apparatus 1 to, in requesting each terminal apparatus 2 for a CSI report, transmit, to the terminal apparatus 2, a CSI trigger that asks the terminal apparatus 2 whether to take a modulo operation into account. Further, the terminal apparatus 2 can determine, according to the CSI trigger, whether to take a modulo operation into account in performing a CSI report. This allows the base station apparatus 1 to appropriately determine a precoding scheme and a MCS in performing precoding MU-MIMO transmission including nonlinear precoding. This makes it possible to improve transmission quality and, by extension, contribute to improvement in frequency usage efficiency of the wireless communication system.

### 2. Second Embodiment

In the second embodiment, the base station apparatus 1 and the terminal apparatus 2 each include a plurality of CQI tables or MCS set tables. Moreover, a CSI trigger of which the base station apparatus 1 notifies the terminal apparatus 2 is used to change from using a CQI table and an MCS set to using another CQI table and another MCS set.

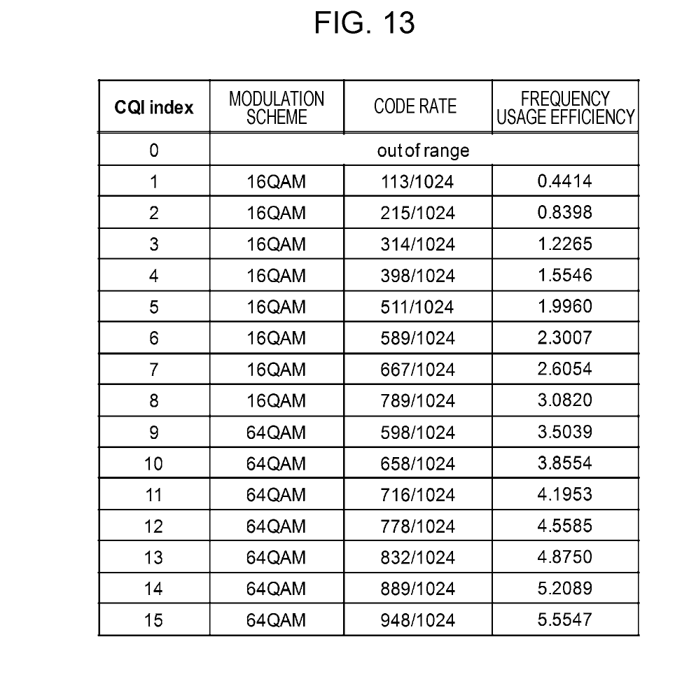

FIG. 13 shows an example of a second CQI table according to the second embodiment. It is assumed here that the CQI table shown in FIG. 2 is a first CQI table and the base station apparatus 1 and the terminal apparatus 2 includes the first and second CQI tables.

Unlike the first CQI table, the second CQI table is configured not to include QPSK modulation. This is because a modulo operation has a profound effect on the reception quality of a QPSK modulation signal. In the second embodiment, a terminal apparatus 2 (second terminal apparatus) that is configured by a CSI trigger to take a modulo operation into account performs a CSI report with reference to the second CQI table.

The use of such a second CQI table by the second terminal apparatus allows the second terminal apparatus to flexibly select CQI in a region where nonlinear precoding can be performed with comparatively high efficiency. Meanwhile, it is only necessary to use the first CQI table for a first terminal apparatus.

It should be noted that the configuration of the second CQI table is not limited to that shown in FIG. 13. The second CQI table needs only be smaller in the percentage of QPSK modulation in the CQI table than the first CQI table. For example, the ratio between 16QAM modulation and 64QAM modulation, their respective code rates, and the number of MCS sets described in the CQI table may be different from those shown in FIG. 13.

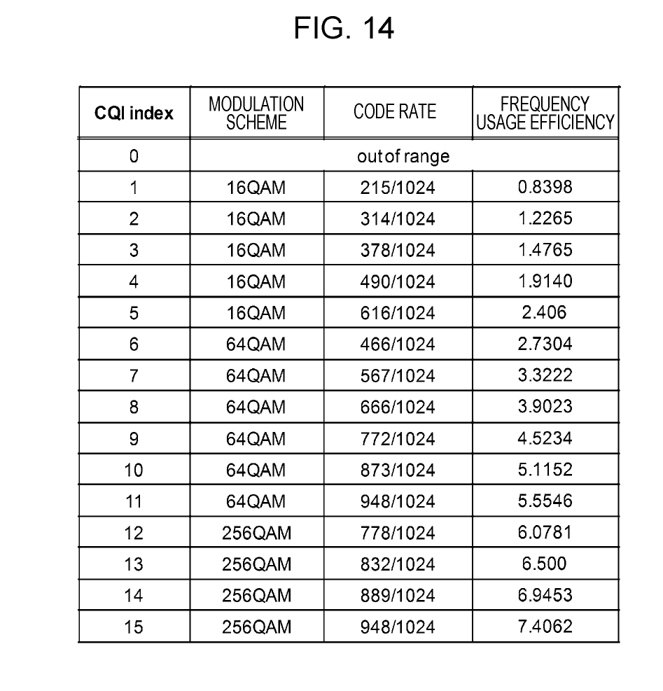

FIG. 14 shows an example of a third CQI table according to the second embodiment. The base station apparatus 1 and the terminal apparatus 2 may be configured to include the first and third CQI tables.

Unlike the second CQI table, the third CQI table is configured to include 256QAM modulation, which makes it possible to attain high frequency usage efficiency. In a case where the first CQI table and the third CQI table are used, the second terminal apparatus uses the third CQI table in performing a CSI report. A data signal destined for the second terminal apparatus is supposed to be subjected to nonlinear precoding by the base station apparatus 1. Moreover, the higher nonlinear precoding is in modulation multivalued number, the higher it becomes in gain than linear precoding. Therefore, the use of the third CQI table, which describes an MCS in which the second terminal apparatus exhibits high frequency usage efficiency, makes it possible to achieve high frequency usage efficiency. Meanwhile, it is only necessary to use the first CQI table for a first terminal apparatus.

It should be noted that the configuration of the third CQI table is not limited to that shown in FIG. 14. The second CQI table needs only include an MCS that exhibits higher frequency usage efficiency than the first CQI table. For example, the ratio between 16QAM modulation, 64QAM modulation, and 256QAM modulation, their respective code rates, and the number of MCS sets described in the CQI table may be different from those shown in FIG. 14.

In a case where the base station apparatus 1 has been notified of “0” as a CQI index, the base station apparatus 1 can determine that the second terminal apparatus is a terminal apparatus that is not suitable to nonlinear precoding. Therefore, at the timing of transmission of the next CSI trigger, the base station apparatus 1 needs only configure a CSI trigger destined for the second terminal apparatus so that the second terminal apparatus performs a CSI report without taking a modulo operation into account.

It should be noted that the base station apparatus 1 receives, from the second terminal apparatus, a CSI report based on the second or third CQI table. The base station apparatus 1 may configure an MCS for a data signal destined for the second terminal apparatus on the basis of the MCSs described in the second or third CQI table. Further, the base station apparatus 1 may configure an MCS on the basis of another MCS table describing a plurality of MCSs that are different from the MCSs described in the second or third CQI table. Note here that another MCS table needs only describe an MCS in which the ranges of frequency usage efficiency described in the second and third CQI tables and frequency usage efficiency therearound can be achieved with higher granularity, and is shared by the base station apparatus 1 and each terminal apparatus 2.

In the second embodiment, the base station apparatus 1 and the terminal apparatus 2 include a plurality of CQI tables or MCS tables. In such a wireless communication system, the base station apparatus 1 can more highly accurately configure an MCS for a data signal destined for the second terminal apparatus that is subjected to nonlinear precoding. This makes it possible to improve the reception quality of the terminal apparatus 2 and, by extension, contribute to improvement in frequency usage efficiency of the wireless communication system.

### 3. Third Embodiment

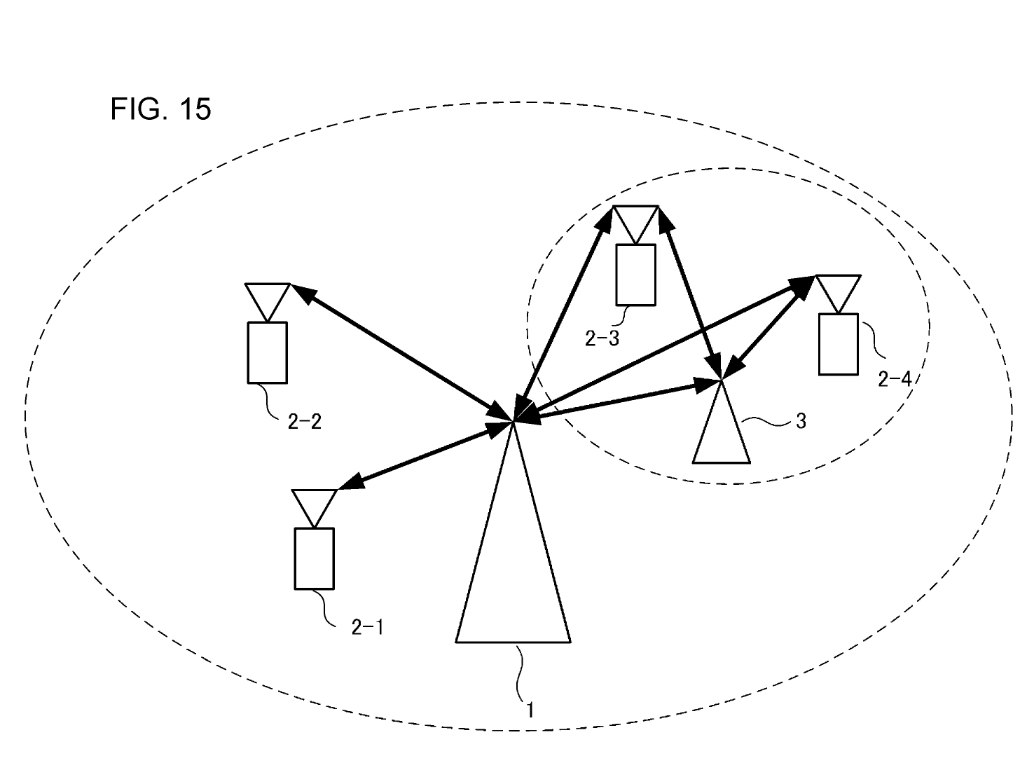

A third embodiment is directed to a wireless communication system in which there are a plurality of small-sized base station apparatuses 3 in a range of communication (called a macrocell) with the base station apparatus 1. FIG. 15 shows an example of the wireless communication system according to the third embodiment. Further, there are terminal apparatuses 2 (terminal apparatuses 2-1 and 2-2, also called third terminal apparatuses) in the macrocell and terminal apparatuses 2 (terminal apparatuses 2-3 and 2-4, also called fourth terminal apparatuses) in a range of communication (called a small cell) with the small-sized base station apparatus 3. Each of the terminal apparatuses 2 is connected to the base station apparatus 1. Further, the base station apparatus 1 and the small-sized base station apparatus 3 can communicate with each other. The interface between the base station apparatus 1 and the small-sized base station apparatus 3 may be wired communication or wireless communication.

FIG. 15 shows only one small-sized base station apparatus 3. However, the third embodiment of course encompasses a case where there are a plurality of small-sized base station apparatuses 3 in the macrocell. Further, the macrocell and the small cell use different carrier frequencies and are directed to a system in which they do not interfere with each other. It should be noted that the small cell uses a higher carrier frequency than the macrocell does.

It should be noted that as with the base station apparatus 1, the small-sized base station apparatus 3 according to the third embodiment is capable of performing precoding including nonlinear precoding on a data signal destined for a terminal apparatus 2 (fourth terminal apparatus) connected thereto, and that the small-sized base station apparatus 3 is identical in apparatus configuration to the base station apparatus 1.

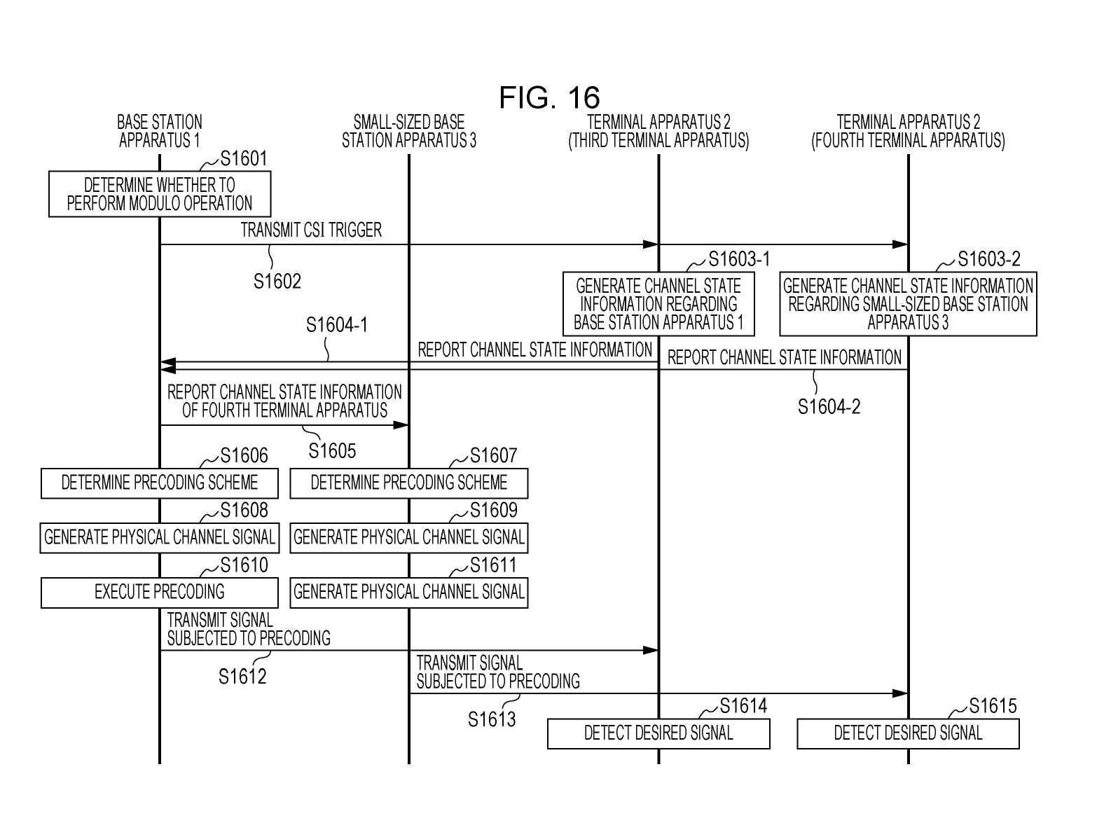

FIG. 16 is a sequence chart showing an example of communication between the base station apparatus 1, the terminal apparatuses 2 (third and fourth terminal apparatuses), and the small-sized base station apparatus 3 according to the third embodiment. FIG. 16 shows only a part of the communication that is relevant to a CSI report. Further, FIG. 16 shows only one third terminal apparatus, one fourth terminal apparatus, and one small-sized base station apparatus 3, although a plurality of these apparatuses may perform the same communication in an actual system. It should be noted that references signals, such as a CRS and a CSI-RS, by which each terminal apparatus 2 estimates CSI are periodically communicated from the base station apparatus 1 and the small-sized base station apparatus 3 by another control. Further, the base station apparatus 1 and the small-sized base station apparatus 3 know whether each terminal apparatus 2 is in the macrocell or the small cell.

First, the base station apparatus 1 determines whether to request each terminal apparatus 2 for a CSI report with a modulo operation in the scope of the assumption (step S1601). In the third embodiment, the base station apparatus 1 does not request the third terminal apparatus for a modulo operation, but requests the fourth terminal apparatus for a modulo operation. This is because the third terminal apparatus, which tends to be comparatively low in reception quality, is not suitable to nonlinear precoding, while the fourth terminal apparatus, which tends to be comparatively high in reception quality, is suitable to nonlinear precoding. Of course, the base station apparatus 1 may determine, on the basis of another norm, whether to request for a modulo operation.

Next, the base station apparatus 1 transmits a CSI trigger to each terminal apparatus 2 (step S1602).

Next, each terminal apparatus 2 generates CSI on the basis of the CSI trigger notified from the base station apparatus 1. The third terminal apparatus generates CSI between the third terminal apparatus and the small-sized base station apparatus 3 (step S1603-1), and the fourth terminal apparatus generates CSI between the fourth terminal apparatus and the base station apparatus 1 (step S1603-2). Then, each terminal apparatus 2 reports the CSI thus generated to the base station apparatus 1 (steps S1604-1 and S1604-2).

Next, the base station apparatus 1 notifies the small-sized base station apparatus 3 of the contents of the CSI report from the fourth terminal apparatus (step S1605).

Next, on the basis of the CSI report from the third terminal apparatus, the base station apparatus 1 determines a precoding scheme that is applied to a data signal destined for the third terminal apparatus (step S1606). Further, on the basis of the CSI report from the fourth terminal apparatus as notified from the base station apparatus 1, the small-sized base station apparatus 3 determines a precoding scheme that is applied to a data signal destined for the fourth terminal apparatus (step S1607). It should be noted that steps S1606 and S1607 may be skipped in a case where the base station apparatus 1 is predetermined to use nonlinear precoding and the small-sized base station apparatus 3 is predetermined to use nonlinear precoding.

Next, on the basis of the CSI report from the third terminal apparatus and the precoding scheme, the base station apparatus 1 determines an MCS that is applied to the data signal destined for the third terminal apparatus and generates a physical channel signal (step S1608). Similarly, on the basis of the CSI report from the fourth terminal apparatus and the precoding scheme, the small-sized base station apparatus 3 determines an MCS that is applied to the data signal destined for the fourth terminal apparatus and generates a physical channel signal (step S1609).

Next, the base station apparatus 1 and the small-sized base station apparatus 3 performs precoding on the physical channel signals thus generated (steps S1610 and S1611), and then transmit, to the respective terminal apparatuses 2, the signals subjected to precoding (steps S1612 and S1613).

Each terminal apparatus 2 demodulates a desired signal from the signal received (steps S1614 and S1615).

The method thus described enables each terminal apparatus 2 to perform an appropriate CSI report to the base station apparatus 1 or the small-sized base station apparatus 3 to which it is connected on the basis of a CSI trigger that is transmitted from the base station apparatus 1. Further, the base station apparatus 1 and the small-sized base station apparatus 3 are each capable of appropriately configuring an MCS for a data signal destined for the terminal apparatus 2 connected thereto.

In the method thus described, the fourth terminal apparatus, too, always reports calculated CSI to the base station apparatus 1. Alternatively, the fourth terminal apparatus may perform a CSI report directly to the small-sized base station apparatus 3. In this case, the CSI trigger of which the base station apparatus 1 notifies each terminal apparatus 2 may contain information that designates whether to report CSI to the base station apparatus 1 or the small-sized base station apparatus 3.

It should be noted that the third terminal apparatus and the fourth terminal apparatus may differ in type of information regarding a MIMO channel. For example, it is conceivable that the third terminal apparatus may report information having a certain degree of low accuracy (e.g., PMI) to the base station apparatus 1 and the fourth terminal apparatus may report information having a certain degree of high accuracy (e.g., information directly representing a MIMO channel) to the small-sized base station apparatus 3. This is because nonlinear precoding that the small-sized base station apparatus 3 is highly likely to perform requires highly accurate channel state information. In this case, the CSI trigger of which the base station apparatus 1 notifies each terminal apparatus 2 may contain information that designates the accuracy of MIMO channel information on the basis of which a CSI report is performed.

It should be noted that as in the second embodiment, a plurality of different CQI tables may be shared by the base station apparatus 1, the small-sized base station apparatus 3, and the terminal apparatuses 2. In this case, the fourth terminal apparatus may be controlled to use the second and third CQI tables, and the third terminal apparatus may be controlled to use the first CQI table. Further, the base station apparatus 1 may also use a CSI trigger to ask each terminal apparatus 2 which CQI table to use.

The method thus described allows the base station apparatus 1 to use a CSI trigger to ask each terminal apparatus 2 whether to take a modulo operation into account. Further, in generating CSI between the terminal apparatus 2 and the base station apparatus 1 or the small-sized base station apparatus 3, the terminal apparatus 2 can determine, according to the CSI trigger, whether to take a modulo operation into account. This allows the base station apparatus 1 and the small-sized base station apparatus 3 to appropriately determine MCSs that are applied to data signals destined for the terminal apparatuses 2, respectively, thus bringing about improvement in transmission quality.

### 4. Common Features of the Embodiments

The description of each of the embodiments is based on aperiodic channel state information reporting, but is also applicable to a case where periodic channel state information reporting is performed. For example, information that designates whether to take a modulo operation into account may be contained in signaling that designates information that the terminal apparatus 2 performs periodic channel state information reporting to the base station apparatus 1 (such as signaling that designates a feedback mode in LTE).

Further, in the present invention, a CSI trigger contains information that designates whether to take a modulo operation into account. In this case, the contents of information regarding a MIMO channel that the terminal apparatus 2 reports may vary depending on whether to take a modulo operation into account. For example, a terminal apparatus 2 requested for a CSI report with a modulo operation taken into account reports highly accurate MIMO channel information (e.g., information directly representing a MIMO channel) to the base station apparatus 1. Moreover, a terminal apparatus 2 requested for a CSI report without a modulo operation taken into account may be controlled to report less-accurate MIMO channel information (e.g., PMI) to the base station apparatus 1. This is because nonlinear precoding requires more highly accurate MIMO channel information than linear precoding does. However, if all of the terminal apparatuses 2 perform CSI reports on the basis of highly accurate MIMO channel information, there is undesirably an increase in overhead. Therefore, by changing, on the basis of a CSI trigger, information regarding a MIMO channel that the terminal apparatus 2 reports, the increase in overhead can be suppressed.

Further, in the present invention, a signal that is contained in a CSI trigger is intended to designate whether to take a modulo operation into account in performing a CSI report. However, in the present invention, it is possible for the base station apparatus 1 to request the terminal apparatus 2 for a CSI report based on a different norm without being limited to a modulo operation. For example, in requesting the terminal apparatus 2 for CQI in a case where PMI is used as information regarding a MIMO channel or CQI in a case where information directly representing a MIMO channel is used, the base station apparatus 1 may use a CSI trigger to ask the terminal apparatus 2 on which norm to base CQI calculation. Further, in asking whether to use less-accurate information (e.g., PMI) or highly accurate information (e.g., information directly representing a MIMO channel) as the information regarding a MIMO channel, the base station apparatus 1 may also use a CSI trigger to notify the terminal apparatus 2 which information regarding a MIMO channel to request. Further, the base station apparatus 1 may also use a CSI trigger to ask a terminal apparatus 2 that receives a plurality of reference signals on which reference signal to base a CSI report.

Further, in the present invention, the base station apparatus 1 selects linear precoding, nonlinear precoding, or a combination of linear precoding and nonlinear precoding and applies it to a data signal destined for each terminal apparatus 2. The base station apparatus 1 changes the contents of a CSI trigger destined for each terminal apparatus 2 according to a precoding scheme that is supposed to be applied to a data signal destined for each terminal apparatus 2. Note here that a precoding scheme that the base station apparatus 1 can apply is not limited to those mentioned above. For example, the base station apparatus 1 may give a transmission power difference between the base station apparatus 1 and the terminal apparatus 2 to enable non-orthogonal access (also called superimposed communication) that enables simultaneous multiplex transmission. Moreover, in the same manner as the present invention, the base station apparatus 1 may also request for a CSI report on the assumption that data signals are multiplexed by superimposed communication to each terminal apparatus 2.

Embodiments of the present invention have been described in detail with reference to the drawings. However, a specific configuration is not limited to these embodiments, and design variations and the like are also encompassed in the scope of claims, provided such variations do not depart from the gist of the invention.

It should be noted that the present invention is not limited to the embodiments described above. A base station apparatus 1, a terminal apparatus 2, and a small-sized base station apparatus 3 of the present invention are not limited to being applied to a terminal apparatus of a cellular system or the like, and are of course applicable to stationary or immovable electronic devices that are installed indoors or outdoors such as audiovisual equipment, kitchen appliances, cleaning and washing machines, air-conditioning equipment, office devices, vending machines, and other domestic appliances.

A program that runs on a base station apparatus 1, a terminal apparatus 2, and a small-sized base station apparatus 3 according to the present invention is a program that controls a CPU or the like (i.e., a program that causes a computer to function) so that the functions of the above-described embodiments of the present invention are achieved. Moreover, information that is handled by these devices is temporarily accumulated in RAM during processing thereof, stored in various types of ROM and/or HDD after that, and read out by the CPU as needed for modification and/or writing. Examples of a storage medium in which the program is stored may include semiconductor media (such as ROM and nonvolatile memory cards), optical storage media (such as DVDs, MOs, MDs, CDs, and BDs), magnetic storage media (such as magnetic tapes and flexible disks). Further, not only are the functions of the embodiments described above achieved by executing the program loaded, but also the functions of the present invention may be achieved by executing processing in cooperation with an operating system or another application program on the basis of instructions from the program.

Further, the program can be distributed to the market by being stored in a portable storage medium or being transferred to a server computer connected via a network such as the Internet. In this case, a storage device of the server computer is also encompassed in the present invention. Further, one, some, or all of the base station apparatus 1, the terminal apparatus 2, and the small-sized base station apparatus 3 in the embodiments described above may be achieved as an LSI that is typically an integrated circuit. Each functional block of the base station apparatus 1, the terminal apparatus 2, and the small-sized base station apparatus 3 may separately take the form of a processor, or one, some, or all of them may be integrated into a processor. Further, in a case where a technology of integrated circuit construction alternative to LSI comes out due to the advancement of technology, it is possible to use integrated circuits based on such a technology.

### INDUSTRIAL APPLICABILITY

The present invention is suitably applicable to a communication system, a base station apparatus, and a terminal apparatus.

The present disclosure contains subject matter related to that disclosed in Japanese Priority Patent Application JP 2013-231256 filed in the Japan Patent Office on Nov. 7, 2013, the entire contents of which are hereby incorporated by reference.

### REFERENCE SIGNS LIST

1 Base station apparatus
2, 2-1, 2-2, 2-3, 2-4 Terminal apparatus
3 Small-sized base station apparatus
701, 1004 Control unit
702 Control signal generation unit
703, 1007 Wireless transmitting unit
704, 1001 Antenna
705, 1002 Wireless receiving unit
706 CSI acquisition unit
707, 1006 Physical channel signal generation unit
708 Precoding unit
1003 Channel estimation unit
1005 CSI generation unit
1008 Physical channel signal demodulation unit

1. A communication system in which a terminal apparatus notifies a base station apparatus of channel state information,
the base station apparatus comprising:
a step of choosing a channel information norm from among a plurality of candidates as a norm of channel state information that the base station apparatus requests the terminal apparatus to conform to;
a step of generating control information containing information that designates the chosen channel information norm; and
a step of transmitting the control information to the terminal apparatus,
the terminal apparatus comprising:
a step of receiving the control information;
a step of estimating a channel between the terminal apparatus and the base station apparatus;
a step of generating channel state information between the terminal apparatus and the base station apparatus on a basis of the control information and the estimated channel between the terminal apparatus and the base station apparatus; and
a step of reporting the channel state information to the base station apparatus,
wherein the channel information norm includes a norm according to which the terminal apparatus calculates channel state information while taking a perturbation vector into account and a norm according to which the terminal apparatus calculates channel state information without taking a perturbation vector into account.

2. The communication system according to claim 1, wherein the terminal apparatus further comprises:
a step of estimating a channel between the terminal apparatus and a small-sized base station apparatus that is present in a range of communication with the base station apparatus;
a step of generating channel state information between the terminal apparatus and the small-sized base station apparatus on a basis of the control information and the estimated channel between the terminal apparatus and the small-sized base station apparatus; and
a step of reporting the channel state information between the terminal apparatus and the small-sized base station apparatus to the base station apparatus, and
the base station apparatus further comprises:
a step of notifying the small-sized base station apparatus of the channel state information between the terminal apparatus and the small-sized base station apparatus as reported from the terminal apparatus; and
a step of acquiring the channel state information of which the base station apparatus notified the small-sized base station apparatus.

3. The communication system according to claim 2, wherein the control information further contains information that designates whether the terminal apparatus reports the channel state information to the base station apparatus or the small-sized base station apparatus.

4. A base station apparatus that receives channel state information from a plurality of terminal apparatuses, comprising:
a control unit that chooses a channel information norm from among a plurality of candidates as a norm of channel state information that the base station apparatus requests each of the terminal apparatuses to conform to;
a control information generation unit that generates control information containing information that designates the chosen channel information norm; and
a wireless transmitting unit that transmits the control information to the terminal apparatus,
wherein the channel information norm includes a norm according to which the terminal apparatus calculates channel state information while taking a perturbation vector into account and a norm according to which the terminal apparatus calculates channel state information without taking a perturbation vector into account.

5. The base station apparatus according to claim 4, wherein the channel state information reported from one or some of the plurality of terminal apparatuses is notified to a small-sized base station apparatus that is present in a range of communication with the base station apparatus.

6. The base station apparatus according to claim 5, wherein the control information further contains information that designates whether the one or some of the plurality of terminal apparatuses report(s) the channel state information to the base station apparatus or the small-sized base station apparatus.

7. The base station apparatus according to claim 4, further comprising a plurality of channel quality indicator tables describing a plurality of combinations of a code rate and a modulation scheme,
wherein the plurality of channel quality indicator tables correspond to the channel information norms, respectively.

8. A terminal apparatus that notifies a base station apparatus of channel state information, comprising:
a wireless receiving unit that receives control information containing information that designates a channel information norm that is a norm of channel state information transmitted from the base station apparatus;
a propagation channel estimation unit that estimates a channel between the terminal apparatus and the base station apparatus;
a channel state information generation unit that generates channel state information between the terminal apparatus and the base station apparatus on a basis of the channel information norm designated by the control information and the estimated channel between the terminal apparatus and the base station apparatus; and
a wireless transmitting unit that transmits the channel state information to the base station apparatus,
wherein the channel information norm includes a norm according to which the channel state information generation unit calculates channel state information while taking a perturbation vector into account and a norm according to which the channel state information generation unit calculates channel state information without taking a perturbation vector into account.

9. The terminal apparatus according to claim 8, wherein the propagation channel estimation unit estimates a channel between the terminal apparatus and a small-sized base station apparatus that is present in a range of communication with the base station apparatus,
the channel state information generation unit generates channel state information between the terminal apparatus and the small-sized base station apparatus on a basis of the channel information norm designated by the control information and the estimated channel between the terminal apparatus and the small-sized base station apparatus, and
the wireless transmitting unit transmits the channel state information between the terminal apparatus and the small-sized base station apparatus to the base station apparatus.

10. The terminal apparatus according to claim 9, wherein the wireless transmitting unit is capable of transmitting the channel state information between the terminal apparatus and the small-sized base station apparatus to the small-sized base station apparatus,
the control information further contains information that designates whether to report the channel state information to the base station apparatus or the small-sized base station apparatus, and
whether to report the channel state information between the terminal apparatus and the small-sized base station apparatus to the base station apparatus or the small-sized base station apparatus is determined on a basis of the control information.

11. The terminal apparatus according to claim 8, further comprising a plurality of channel quality indicator tables describing a plurality of combinations of a code rate and a modulation scheme,
wherein the plurality of channel quality indicator tables correspond to the different channel information norms, respectively, and
a channel quality indicator table that the channel state information generation unit uses is chosen on a basis of the control information.
